(19) United States
(12) Patent Application Publication
(10) Pub. No.: US 2025/0074023 A1
(43) Pub. Date: Mar. 6, 2025

(54) METHOD FOR FABRICATING FOOTWEAR USING SACRIFICIAL MOLD

(71) Applicant: Koobz, Ventura, CA (US)

(72) Inventor: Jakub Graczyk, Ventura, CA (US)

(21) Appl. No.: 18/819,729

(22) Filed: Aug. 29, 2024

Related U.S. Application Data
(60) Provisional application No. 63/580,646, filed on Sep. 5, 2023.

(51) Int. Cl. B29D 35/12; B29C 33/38; B29C 64/386; B33Y 50/00; B33Y 80/00

(52) U.S. Cl. CPC B29D 35/128; B29C 33/3835; B29C 33/3842; B29C 64/386; B33Y 50/00; B33Y 80/00

(57) ABSTRACT

A method of fabricating footwear using sacrificial molds that are produced using additive manufacturing. A sacrificial mold for an article of footwear is manufactured from a soluble material by an additive manufacturing process. The article of footwear is then fashioned from the sacrificial mold by introducing an expandable foam into a cavity in the mold, allowing the foam to cure within the mold, and then removing the mold by exposing it to a solvent until dissolved. One or more design elements and/or rigid inserts may be introduced into areas of the mold, for example during manufacture of the mold or during fashioning of the article of footwear. For example, the manufacturing of the sacrificial mold may be temporarily paused during the manufacturing process for addition of the one or more design elements into a semi-completed mold.

### RELATED APPLICATIONS

This application claims the priority benefit of U.S. Provisional Application No. 63/580,646, filed 5 Sep. 2023, which is incorporated herein by reference.

### FIELD OF THE INVENTION

The present invention relates to methods of fabricating footwear using sacrificial molds that are produced using additive manufacturing.

### BACKGROUND

Additive manufacturing is a broad term used to describe processes to fabricate three-dimensional (“3D”) objects from digital data files under computer control. Additive manufacturing is, therefore, sometimes referred to as 3D printing. A number of different additive manufacturing techniques have been developed, including material jetting, direct energy deposition, material extrusion, powder bed fusion, sheet lamination, and vat polymerization. These different techniques typically employ one of three additive manufacturing technologies: sintering, in which a material is heated so that particles of the material adhere to one another, melting, in which a material organized in one form is melted and then allowed to solidify in another form, and stereolithography, in which a photopolymerizable resin is exposed to radiation to cure the resin in desired areas.

Fused deposition modeling or FDM is a form of additive manufacturing that relies on melting to form 3D objects. In FDM processes, a material, typically a thermoplastic, is melted and extruded while in its molten or semi-molten form onto a build platform layer-by-layer, where it then resolidifies to form a desired shape. FDM printers are capable of forming a number of different kinds of objects, including molds. Stereolithography can also be used to fashion molds by selective, layer-by-layer photo-curing of a liquid resin through exposure to ultra-violet (UV) light according to a pattern. In both FDM and stereolithography, each layer is typically a transverse section of the object under construction. Usually, a 3D model of the object to be manufactured is represented in computer software as an ordered succession of layers, and the printing apparatus is operated so as to form the object, either by depositing material in the case of FDM, or by selective irradiation of a liquid resin that is contained in a tank in the case of stereolithography.

Modern footwear often includes injection-molded components. Molds are machined from metals or other materials and components are created by injecting one or more materials into the molds, allowing the materials to cool, and then extracting the components from the molds. The molds can then be cleaned and reused. For example, outsoles, mid-soles, heels, and other components are often produced in this fashion. And, shoemakers are beginning to use 3D printing technologies, for example to create lasts on which new footwear designs can be based. Some manufacturers have even introduced 3D-printed footwear. Among the purported benefits of 3D printed shoes is that manufacturers can skip the process of molding parts and then assembling individual shoes of various sizes, and instead print entire shoes on-demand. This is said to reduce, if not eliminate, waste in the manufacturing process, eliminate, or at least reduce, the need for extensive inventories, and allow for more rapid development of new shoe types and designs. Despite these professed benefits, however, 3D printed shoes remain a somewhat niche item and the footwear industry still relies, for the most part on more traditional methods of shoe making.

### SUMMARY OF THE INVENTION

The present invention provides methods of fabricating footwear using sacrificial molds that are produced using additive manufacturing. In one embodiment, such a method involves manufacturing a sacrificial mold for an article of footwear from a soluble material by an additive manufacturing process, fashioning the article of footwear from the sacrificial mold by introducing an expandable foam into a cavity in the mold, allowing the foam to cure within the mold, and then removing the mold by exposing it to a solvent until dissolved. Such a sacrificial mold may be manufactured (e.g., manufactured by one of a fused deposition modeling (FDM) process, a vat polymerization process, or a selective laser sintering (SLS) process) from a digital model thereof. For example, the sacrificial mold may be created from a digital model of a shoe. The digital model of the shoe may itself be created from a digital model of a foot or a digital model of a last. In the sacrificial mold surfaces thereof may be offset from surfaces of a digital model, e.g., that of a shoe, by one or more desired distances.

In various embodiments, one or more design elements may be introduced into one or more areas of the mold. Similarly, one or more rigid inserts may be introduced into one or more areas of the mold, for example during manufacture of the mold or during fashioning of the article of footwear. Accordingly, the manufacturing of the sacrificial mold may be temporarily paused during the manufacturing process for addition of the one or more design elements into a semi-completed mold. Such design elements may include one or more rigid design elements, design elements that are inserted in cavities in a semi-completed mold, a rigid mid-sole, cleats, spikes, attachment points for cleats or spikes, anchor points, faux stitching, ridges, logos, geometric elements, personalizations, representations of animals, objects, or scenes, tread patterns or elements, holes for laces or other fasteners, pockets or other supports for sensors, and/or attachment points for outsoles, midsoles, or other components.

### BRIEF DESCRIPTION OF THE DRAWINGS

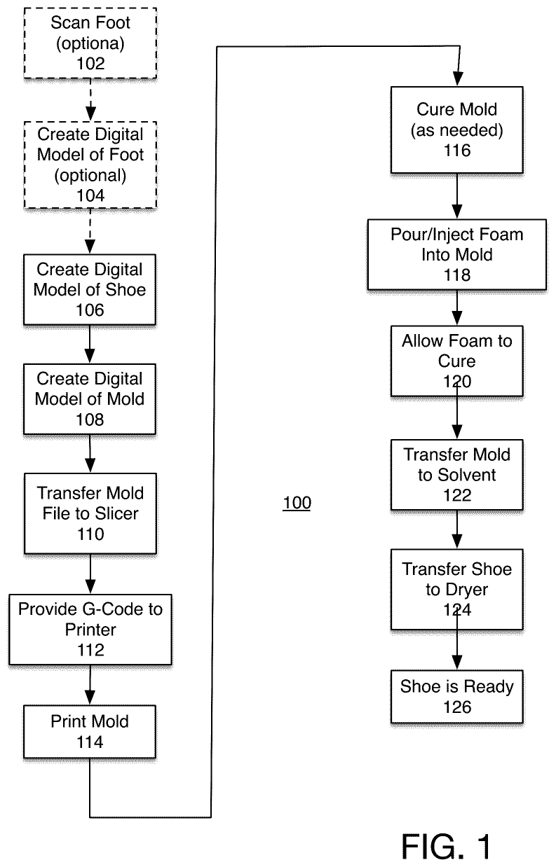

The present invention is illustrated by way of example, and not limitation, in the figures of the accompanying drawings in which FIG. 1 illustrates an example of a method of fabricating footwear using sacrificial molds that are produced using additive manufacturing in accordance with an embodiment of the invention.

### DESCRIPTION OF THE INVENTION

The present invention provides methods of fabricating footwear using sacrificial molds that are produced using additive manufacturing.

In one embodiment, in order to fashion a sacrificial mold for a shoe, a digital scan of a foot is taken and the scan data is used to create a digital model of the shoe. Alternatively, the digital model of the shoe may be made from a scan of an existing shoe, a scan of an existing shoe last, two-dimensional photos of a shoe or a last, or may be created without reference to an existing shoe or last using computer aided design (“CAD”) software. Using the digital model of the shoe, a digital model of a mold may be made by offsetting inner surfaces thereof from outer surfaces of the digital model of the shoe by a desired distance. These distances may vary over the entire surface of the model of the shoe, for example with greater distances being used for areas of the sole than for the uppers.

Once that digital model of the mold is available, it is provided to a slicer program, which is used to create a layer-by-layer representation of the mold for an additive manufacturing printer. The g-code produced by the slicer program will instruct the printer as to how to produce the mold in a layer-by-layer fashion. In various embodiments, the printer may be an FDM printer, a vat photopolymerization printer, or another form of additive manufacturing printer. Importantly, the printer fashions the mold according to the layer-by-layer printing instructions using a material that is dissolvable by a solvent, such as water. Once the mold is complete, it may be dried and cured.

The finished mold is then used to fashion the shoe. In one embodiment, an expandable foam is poured into the mold and allowed to expand therein, thus forming the shoe. In some cases, vacuum and/or a centrifugal spinner may be used to ensure a uniform application of the expandable foam within the entire cavity of the mold. Rigid elements such as carbon fiber inserts may be added to provide rigidity to the mid-sole of the shoe and the expandable foam may coalesce around such elements, embedding them within the shoe as the foam cures.

Once the foam has cured, the mold with the newly formed shoe therein is transferred to a solvent bath. As mentioned, this may be a water bath or a bath in another solvent. The bath may be agitated to aid in the process of dissolving the mold from around the shoe. Once the mold has dissolved, the shoe is removed from the bath and transferred to a drying station where it is dried (e.g., by heating). In some cases, the mold may also be subjected to vapor smoothing, for example using acetone vapors, to provide a smooth interior surface so that the outer surface of the shoe produced by the mold is also smooth.

By employing sacrificial molds, the present invention greatly reduces the costs associated with new footwear development. Fabricating metal molds, as is usually done in the footwear industry, is an expensive and time consuming process. As such, changing molds, e.g., to suit new design trends, is not something that can easily be undertaken. With easily produced sacrificial molds, however, a footwear designer can produce new molds rapidly, as needed, when needed, and incur very little cost in doing so. They are ideally suited for low-volume production as may be the case with dealing with trendy or fashion-forward shoe designs, and because the molds can be created using off-the-shelf CAD software (e.g., Fusion 360™ software from Autodesk Inc.), they can be designed by persons with only basic computer design skills. Traditional molds for injection molding processes are typically produced only by skilled mold makers and require specialized tooling and machines for their fabrication. Additionally, using sacrificial molds produced by FDM or vat photopolymerization from water-soluble resins allows for molding of complex geometries that may not be readily achievable using traditional injection molding of two-part metal molds. For example, sacrificial molds made from water-soluble resins may incorporate undercuts and other design features that are difficult to incorporate in metal molds. In some cases, the mold may be made via selective laser sintering (SLS), in which a powdered material is sintered, layer-by-layer, to form the mold.

Referring now to FIG. 1, further details of the present invention are provided. As mentioned, shoes can be designed from digital scans of an individual's foot/feet. At 102, such a scan is taken, for example using a digital scanner such as a FitTech™ scanner from Volumental AB of Stockholm Sweden. Such scanners may be stand-alone platforms or applications designed to run on mobile phones or similar devices. In the latter case, the applications make use of cameras and lidar sensors integrated on modern mobile phones. Lidar sensors provide depth sensing for a scene and the depth information is used to create a 3D point cloud or other sensor map that is used to create a 3D model of the individual's foot/feet 104. The stand-alone platforms are similar, but are usually single-purpose devices that provide multiple sensor maps from multiple lidar or similar sensors. The multiple sensor maps are combined to create very detailed, high resolution digital scans of the individual's foot/feet. Of course, other scanners and/or mobile device applications may be used to create the digital scan, and the present invention is not limited to use or application with any one particular digital scanner technology.

As an alternative to a digital scan of an individual's foot/feet, a casting of the individual's foot/feet may be made, for example using plaster or another material. The casting may be used as a mold to then create a replica of the individual's foot/feet. This replica may then be imaged or scanned to create the digital model of the individual's foot/feet 104. In still other embodiments, the individual's foot/feet may be imaged from multiple angles and the images used to create the digital model of the individual's foot/feet using photogrammetry. Of course, if personalization of the shoe is not necessary, then a digital model of a representative foot or even a representative shoe may be used in place of a digital model of a particular individual's foot/feet. For example, a model's foot/feet may be scanned 102 to produce a digital model of a representative foot/feet 104 that will become the basis for creating shoes of a particular size. In this way, digital models for feet of various sizes (e.g., common sizes for adult and children) can be produced and used where personalization or custom fit of the shoes is not needed or desired.

Scanning or creating a replica of a foot/feet in order to create a digital model thereof is optional. While such a digital model of a foot for which a shoe is to be produced may be used to create a digital model of a shoe 106 (e.g., by first using the digital model of the foot to create a digital model of a last and then using the digital model of the last to create the digital model of the shoe), the digital model of the shoe can also be created by a designer using CAD software without having a digital representation of an individual's foot available. For example, the digital model of the shoe 106 may be created from a stored digital representation of a last. Or, the digital model of the shoe may be created from images of an existing shoe, for example by mapping control points onto images of a shoe taken from different vantage points and creating a digital model using those control points. Again, photogrammetry tools such as Adobe Substance 3D Sampler™ from Adobe Inc. of San Jose, CA may be used to create such a model from 2D images of a shoe. Commercially available software such as Shoenaster™ available from Atom s.p.a. of Vigevano, Italy may be used to design a shoe from images or sketches and will produce a 3D digital model of a shoe suitable for use in connection with embodiments of the present invention.

Because the digital model of the shoe will form the basis for creating a mold, the digital model of the shoe is modified by adding gating (pouring) ports and vent holes, as needed. The pouring ports and vent holes will provide access for pouring or injecting the material(s) from which the shoe will be fashioned to the mold that is created from the digital model of the shoe. These ports may be added by the designer in the digital model using the CAD software used to create the digital model of the shoe and may be positioned so as to best permit complete coverage of the material within the interior of the mold. For simple geometries, this may be accomplished using a single set of pouring ports and vent holes, whereas for mor complex geometries additional sets of pouring ports and/or vent holes may be needed. With the digital model of the shoe now ready, a digital model of a mold for the shoe 108 is created. In one embodiment, the digital model of the mold is created by offsetting the surfaces of the digital model of the shoe by a specified distance or distances. For example, an offset of a few millimeters may be specified for portions of a shoe upper, while the offset may be increased to tens of millimeters for the shoe sole, e.g., in order to provide a more cushioned sole. Or, the same offset may be sued for the entire shoe, e.g., if the shoe is to be thin or light weight.

The offset applied to the shoe surfaces will specify the contours of the interior surfaces of the mold. To provide a cavity for a foot, an interior space for the shoe will need to be defied and this too may be specified by offsets from the digital model of the shoe. Thus, the digital model of the mold will resemble a shell having interior surfaces that correspond to the surfaces of the shoe and an interior portion that will not be accessible to materials poured or injected into the mold. This interior portion will ultimately be the space in the shoe into which an individual's foot is inserted. The pouring ports and vent holes defined in the digital model of the shoe are replicated in the digital model of the mold so that when the mold is produced it includes these features.

In addition to the surfaces of the shoe, various design features may be incorporated into the digital model of the mold. For example, features such as spikes or cleats to be located on the outer sole of the shoe can be incorporated. Alternatively, anchor points for such items, e.g., holes for accepting golf spikes or bicycle cleats, may be fashioned in the mold so that when the shoe is printed those features are present. Additionally, design features to appear on the outer or even the inner surface of the shoe may be incorporated into the mold. This may include things like faux stitching; ridges; cavities; designs; logos; geometric elements; personalization, such as names, nicknames, personal sayings, or quotes; representations of animals, objects, or scenes; tread patterns or elements; holes for laces or other fasteners; pockets or other supports for sensors (such as accelerometers, pedometers or strain gauges); secret compartments (e.g., for hiding valuables); attachment points for outsoles, midsoles, or other components; or other design features.

Once the digital model of the mold 108 is complete, the file is transferred or made accessible to a “slicer” program 110. While different CAD software packages vary in terms of their capabilities and features, all generally permit an operator to save an output file that includes specifications of the article of interest, in this case the mold for the shoe, in one of a number of file formats. Common output file formats used in connection with 3D printing technologies include .stl (variously known as standard triangle language, stereolithography, or standard tessellation language), .STEP (standard for the exchange of product data), and .obj (an open file format for representing 3D geometries). Of course, many other file formats compatible with 3D printing technologies exist.

Once the design of the mold is complete, the output file that describes the mold is generated (in one of the various output file formats) and provided to the slicer. Slicer applications may be stand-alone applications that run on computer systems or they may be integrated with a target printer on which the mold is to be manufactured. The slicer application converts the digital representation of the mold described in the output file from the CAD software into specific instructions for the printer. For example, slicer application output files are commonly expressed as g-code, a popular instruction format for computer controlled machining. In general, the slicer application divides the mold described by the CAD output file into a set of successive layers of specified thickness (usually uniform thickness), and then describes the layers as linear or planar movements of a nozzle, extruder, or laser, for an additive manufacturing process, or as planar pixel maps for vat photopolymerization processes. Additional instructions to account for fill and support structures may also be included, for example if the mold includes complex geometries. The output of the slicer application (e.g., the g-code) 112 is then provided to the printer 112 to produce the mold 114.

As part of the creation of the g-code for the printer, an operator may specify which areas of the mold are to be printed with soluble materials, and which, if any, areas are to be printed with other materials, such as carbon fiber plates, that will later be incorporated into the shoe by overmolding of the poured foam. For example, the mold may include a cavity, recess, or other feature in which a carbon fiber plate is to be printed or inserted. Such a plate, e.g., in the form of a mid-sole, may provide rigidity and/or durability for shoes. Similarly, eyelets or other design features such as those discussed above may be specified as elements to be printed with non-soluble materials for later overmolding by the poured foam. For printers that are capable of printing more than one material during a fabrication process, this allows for ease of manufacturing. In other cases, the design elements may need to be added manually during a pause in the printing of the mold. Again, the g-code can be structured so as to include such pauses in the printing process.

At 114, the g-code is provided to the printer to manufacture the mold according to the instructions. Any suitable additive manufacturing printer and process may be used. For example, material extrusion in which a thin filament of solid material, usually a thermoplastic, is heated to melting and forced through a nozzle onto a build platform according to the specified relative motions of the nozzle and build plate may be employed. The heated filament cools and solidifies on the build plate to form the desired mold. In one embodiment, fused deposition molding (FDM) of a water-soluble synthetic polymer such as polyvinyl alcohol (PVA) is employed to fashion the mold. Alternatively, vat polymerization technologies such as stereolithography (SLA), direct light processing (DLP), or liquid crystal display (LCD) printing may be used in conjunction with a water-soluble resin such as xMold™ available from Nexa3D of Ventura, CA may be used. Other printing technologies which lend themselves to fabrication of soluble objects may also be used, for example drop on demand (DOD) technologies in which droplets of material (typically polymers) are selectively deposited and cured on a build plate to form an article.

During printing, and in accordance with the g-code for the mold, design elements such as those described above may be added to the mold as it is being fabricated. As mentioned above, this may be done by the printer using a separate printing head (or multiple heads) to deposit the design element. For example, a separate printing head may be used to deposit a rigid insert into a cavity or other designated location within the mold. The rigid insert may be made of a material such as carbon fiber and may be deposited at locations corresponding to a mid-sole in the completed shoe. The rigid inserts, unlike the other mold materials, will not be dissolved after the shoe is formed. Other design elements such as attachment points for cleats, spikes, etc. or the cleats, spikes, etc. themselves may also be directly printed during fabrication of the mold. Such elements may be printed from non-soluble materials such as thermoplastics, carbon fiber, or other materials. The same is true for any of the above-described design elements. In some cases, rather than using separate print heads, the print material may be swapped and a single, common print head used for printing of both the mold material and the insert or other design element material. Alternatively, or in addition, if the g-code includes pauses, as described above, printing of the mold may be temporarily suspended during such a pause, while an operator inserts a rigid design element or a portion thereof into the semi-completed mold, e.g., into a cavity or other receptacle or space in the mold. This manual insertion of a design element would be applicable, for example, in a vat polymerization printing process where it is typically not practical (for time reasons) to transfer different print materials into and out of a vat, although, such a transfer is possible and the use of different print materials for design elements in vat polymerization printing processes is not excluded by the present invention.

Upon completion of the mold printing process, at 116, the mold completed mold is removed from the printer and allowed to cure, as needed. This may include curing the mold by heating and/or exposure to UV light for a period of time until the mold becomes rigid. In some cases, curing may be effected by simply allowing the mold to stand for a period of time at room temperature. If desired, the inner surfaces of the mold may be smoothed, for example in the case of a mold made of PVA by exposure to acetone vapor in a chamber.

Once the mold has cured, at 118 the shoe fabrication begins by pouring or injecting an expandable foam material into the mold cavity. Any of several different types of expandable foam may be used. For example, a two component foam such as FlexFoam-iT!™ available from Smooth-On Inc. of Macungie, PA, may be used. FlexFoam-iT!foams are two-component, polyurethane foams in which two liquids are first mixed together and then quickly poured into a mold. The two ingredients quickly cure, expanding as they do so, filling the mold cavity. The resulting foam is solid, yet flexible. If any inserts are present within the mold cavity, as discussed above, the insets will become encased in the foam as it expands and cures, thus forming rigid layers or other shapes, which can provide the resulting shoe with relatively inflexible features. This is useful for features such as mid-soles, which provide stability and elasticity for the wearer. There are many different FlexFoam-iT!foam variants available, which allows a shoe manufacturer to select a desired density and other physical properties for the resulting shoe.

Alternatively, ethylene-vinyl acetate (EVA) foams may be used to form the shoe. EVA foams have long been used in shoe manufacture, though historically they were limited to use as mid-soles. More recently, entire shoes formed of EVA foam have become available. Other closed cell foams or even open cell foams may be used, although shoes made of an open cell foam may need to be coated so that they do not allow dirt or water to penetrate the shoe.

Regardless of the material(s) used to form the shoe, it may be added to the mold via the formed pouring port(s) in any of several fashions, For example, it may be poured into the mold by gravity feed, by injection molding, or by a combination of these techniques. The material may be introduced under vacuum and/or a centrifugal spinner may be used so as to ensure the material penetrates into all areas of the mold cavity. In some cases, material may be added via several pouring ports, though care should be taken to ensure that different areas of material introduced via separate pouring ports has time to mix together before curing so that the shoe cures as a single object and not along different boundaries.

Once the entire mold has been filled, the expandable foam is allowed to cure within the mold 120. This may take anywhere from a few minutes to a few hours. For example, the FlexFoam-iT!foams typically cure within about 2-4 hours at room temperatures. In some cases, curing may be done at elevated temperatures and/or in dust-free environments in order to reduce the introduction of contaminants to the curing foam.

Once the foam has cured, the mold is removed by dissolving it in a solvent 122. Depending on the mold material that was used an appropriate solvent might be water, which may or may not be heated and/or agitated (e.g., using ultrasound), or another solvent. Water-soluble materials are preferred for forming molds because of the ease of their subsequent removal. A warm water bath is all that is needed. Following the dissolving of the mold, the shoe can then be removed from the bath and dried in a dryer 124. Once dry, the new shoe is ready 128.

Thus, methods of fabricating footwear using sacrificial molds that are produced using additive manufacturing.

What is claimed is:

1. A method of fabricating an article of footwear using a sacrificial mold produced by an additive manufacturing technology, the method comprising:
manufacturing a sacrificial mold for an article of footwear from a soluble material by an additive manufacturing process;
fashioning the article of footwear from the sacrificial mold by introducing an expandable foam into a cavity in the mold, allowing the foam to cure within the mold, and then removing the mold by exposing it to a solvent until dissolved.

2. The method of claim 1, wherein the sacrificial mold is manufactured from a digital model thereof.

3. The method of claim 2, wherein the digital model of the sacrificial mold is created from a digital model of a shoe.

4. The method of claim 3, wherein the digital model of the shoe is created from a digital model of a foot.

5. The method of claim 3, wherein the digital model of the shoe is created from a digital model of a last.

6. The method of claim 2, wherein the digital model of the sacrificial mold is created by offsetting surfaces thereof from surfaces of a digital model of a shoe by one or more desired distances.

7. The method of claim 2, wherein the sacrificial mold is manufactured by one of a fused deposition modeling (FDM) process, a vat polymerization process, or a selective laser sintering (SLS) process.

8. The method of claim 1, wherein one or more design elements are introduced into one or more areas of the mold.

9. The method of claim 1, wherein one or more rigid inserts are introduced into one or more areas of the mold.

10. The method of claim 9, wherein the one or more rigid inserts are introduced into the one or more areas of the mold during manufacture of the mold.

11. The method of claim 9, wherein the one or more rigid inserts are introduced into the one or more areas of the mold during fashioning of the article of footwear.

12. The method of claim 1, wherein during manufacturing of the sacrificial mold, said manufacturing is temporarily paused for addition of one or more design elements into a semi-completed mold.

13. The method of claim 12, wherein the one or more design elements include a rigid design element.

14. The method of claim 12, wherein the one or more design elements are inserted in cavities in the semi-completed mold.

15. The method of claim 12, wherein the one or more design elements include a rigid mid-sole.

16. The method of claim 12, wherein the one or more design elements include one or more of cleats; spikes; attachment points for cleats or spikes; anchor points; faux stitching; ridges; logos; geometric elements; personalizations; representations of animals, objects, or scenes; tread patterns or elements; holes for laces or other fasteners; pockets or other supports for sensors; and attachment points for outsoles, midsoles, or other components.
